(19) United States
(12) Patent Application Publication
(10) Pub. No.: US 2007/0139349 A1
(43) Pub. Date: Jun. 21, 2007

(54) DRIVING IC FOR A DISPLAY DEVICE

(76) Inventors: Soo-jung Yoon, Seoul (KR); Kyung-myun Kim, Seoul (KR)

Correspondence Address: Frank Chau, Esq.;F. CHAU & ASSOCIATES, LLC, 130 Woodbury Road, Woodbury, NY, 11797, US

(21) Appl. No.: 11/557,364

(22) Filed: Nov. 7, 2006

(30) Foreign Application Priority Data
Dec. 13, 2005 (KR) 10-2005-0122552

(51) Int. Cl. G09G 3/36

(52) U.S. Cl. 345/100

(57) ABSTRACT

A driving IC for a display device that reduces the number of circuits included in a source driver, thereby decreasing the entire chip area of the driving IC. The driving IC drives a panel including a plurality of pixels whose respective gradations are represented by M-bit gradation data, and includes a memory storing gradation data for representing respective gradations of the plurality of pixels, a multiplexer unit receiving the gradation data from the memory and transmitting the M-bit gradation data through L transmission lines, where L is less than M, and a source driver serially receiving the gradation data through the L transmission lines and sequentially processing the serially received gradation data.

### CROSS-REFERENCE TO RELATED PATENT APPLICATION

This application claims the benefit of Korean Patent Application No. 10-2005-0122552, filed on Dec. 13, 2005, in the Korean Intellectual Property Office, the disclosure of which is incorporated herein its entirety by reference.

### BACKGROUND OF THE INVENTION

1. Technical Field

The present disclosure relates to a driving IC for a display device, and more particularly, to a driving IC for a display device that reduces the number of circuits included in a source driver, thus decreasing the entire chip area of the driving IC.

2. Discussion of the Related Art

A liquid crystal display (LCD) is widely used as a display device for notebook computers, monitors and so on. The LCD has a panel for displaying images, and the panel includes a plurality of pixels. The plurality of pixels are respectively formed at intersections of a plurality of scan lines transferring a gate select signal and a plurality of data lines transferring color data, that is, gradation data.

A driving IC for driving a display device such as an LCD can be designed such that a scan driver for driving scan lines and a source driver for driving data lines are integrated in a single chip. A conventional driving IC for a display device will now be explained with reference to FIG. 1.

FIG. 1 is a block diagram of a conventional driving IC for a display device. The driving IC includes a memory 10 and a source driver 20. The memory 10 stores gradation data corresponding to frames of images to be displayed on a panel. The gradation data is transmitted to the source driver 20 through a scan port of the memory 10. In this example, all the gradation data bits are respectively transmitted in parallel thorough transmission lines.

The size of the memory 10 decreases as the driving IC becomes more highly integrated. There is a limitation in reducing the size of the source driver 20, however, because a voltage applied to the source driver 20 is restricted. Thus, a routing space between the memory and the source driver 20 is remarkably increased due to a mismatch between the pitch of the memory 10 and the pitch of the source driver 20. Furthermore, in the case where the gradation data transmitted in parallel to the source driver 20 is processed for inversion or for black and white display, more circuits are required in the source driver 20 to simultaneously process the gradation data.

Accordingly, there is a limitation on how much the degree of integration of the conventional driving IC for a display device can be improved.

### SUMMARY OF THE INVENTION

Exemplary embodiments of the present invention provide a driving IC for a display device, that can solve the problem that there is a limitation in improving IC the degree of integration of a driving IC due to an increase in routing space between the memory and the source driver and an increase in the circuit size of the source driver.

According to an exemplary embodiment of the present invention, there is provided a driving IC for a display device including a plurality of pixels whose respective gradations are represented by M-bit gradation data. The driving IC comprises a memory storing gradation data for representing gradations of the plurality of pixels, a multiplexer unit receiving the gradation data from the memory and transmitting the M-bit gradation data through L transmission lines, where L is less than M, and a source driver serially receiving the gradation data through the L transmission lines and sequentially processing the serially received gradation data.

The multiplexer unit may comprise at least one M/L-to-1 multiplexers, where M/L is an integer. The M/L-to-1 multiplexer may receive M/L-bit gradation data and sequentially output the M/L-bit gradation data bits through a single transmission line.

The source driver may comprise at least one data processor that sequentially processes the gradation data serially input through a transmission line. The source driver may further comprise at least one latch unit connected to the data processor.

The latch unit serially receives the M/L-bit gradation data processed by the data processor from the data processor, latches the received M/L-bit gradation data, and outputs the latched M/L-bit gradation data in parallel.

According to an exemplary embodiment of the present invention, there is provided a driving IC for a display device including a plurality of pixels whose respective gradation are represented by M-bit gradation data. The driving IC comprises a memory storing gradation data for representing gradation of the plurality of pixels, a multiplexer unit comprising at least one M/L-to-1 multiplexer, where M/L is an integer, receiving the gradation data from the memory, and transmitting the M-bit gradation data through L transmission lines, where L is less than M, a source driver comprising at least one data processor connected to the M/L-to-1 multiplexer and serially receiving M/L-bit gradation data from the M/L-to-1 multiplexer, and a control signal generator generating a control signal for controlling the M/L-to-1 multiplexer to sequentially output the M/L-bit gradation data bits.

According to an exemplary embodiment of the present invention, there is provided a driving IC for a display device including a plurality of pixels, the gradation of each of the plurality of pixels being represented by M-bit gradation data. The driving IC comprises a memory storing gradation data for representing gradations of the plurality of pixels, a multiplexer unit receiving the gradation data from the memory and transmitting the M-bit gradation data through L transmission lines, where L is less than M, and a source driver serially receiving the gradation data through the L transmission lines and sequentially processing the serially received gradation data. The source driver comprises at least one first latch unit connected to the multiplexer unit through a transmission line to receive and latch the gradation data, and at least one data processor receiving the gradation data serially output from the first latch unit and sequentially processing the gradation data.

### BRIEF DESCRIPTION OF THE DRAWINGS

Exemplary embodiments of the present invention will be understood in more detail from the following detailed descriptions taken in conjunction with the attached drawings in which:

FIG. 1 is a block diagram of a conventional driving IC for a display device that includes a memory and a source driver;

FIG. 2 is a block diagram of a driving IC for a display device according to an exemplary embodiment of the present invention;

FIG. 3 is a circuit diagram of a multiplexer used in the system shown in FIG. 2;

FIG. 4 is a circuit diagram of a data processor used in the system shown in FIG. 2;

FIG. 5 is a circuit diagram of a latch unit used in the system shown in FIG. 2;

FIG. 6 is a waveform diagram of control signals for driving the driving IC shown in FIG. 2;

FIG. 7 is a block diagram of a driving IC for a display device according to an exemplary embodiment of the present invention; and

FIG. 8 is a waveform diagram of control signals for driving the driving IC shown in FIG. 7.

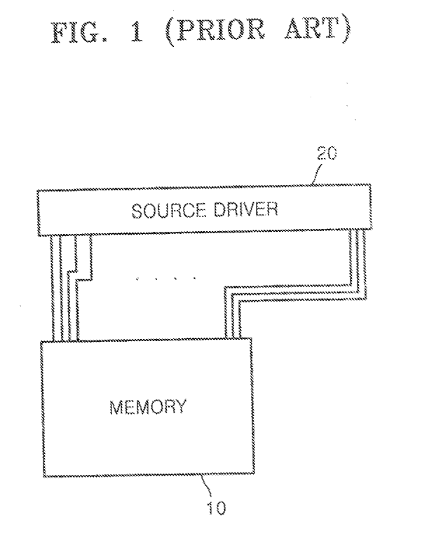

### DETAILED DESCRIPTION OF EXEMPLARY EMBODIMENTS

The present invention will now be described more fully with reference to the accompanying drawings, in which exemplary embodiments of the invention are shown. Throughout the drawings, like reference numerals refer to like elements.

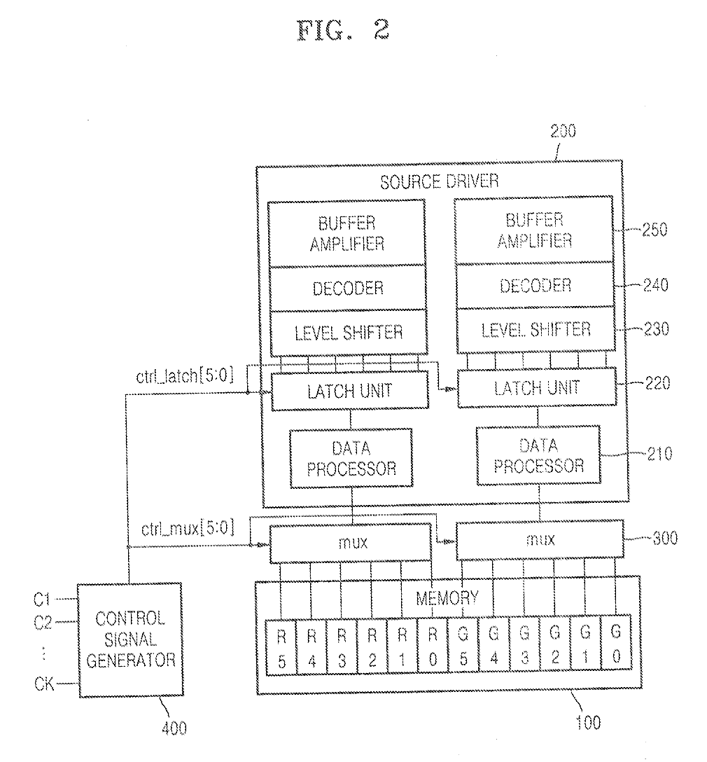

FIG. 2 is a block diagram of a driving IC for a display device according to an exemplary embodiment of the present invention. Referring to FIG. 2, the driving IC for a display device includes a memory 100, a source driver 200 and a multiplexer unit. The driving IC further includes a control signal generator 400 that generates control signals for controlling the source driver 200 and the multiplexer unit.

The source driver 200 receives gradation data from the memory 100, converts the gradation data into an analog signal and transmits the analog signal to a panel (not shown) for display. The source driver 200 includes at least one data processor 210, at least one latch unit 220, at least one level shifter 230, at least one decoder 240 and at least one butter amplifier 250.

The memory 100 stores the gradation data corresponding to frames of images to be displayed on the panel. The panel includes a plurality of pixels. M-bit gradation data is applied to each of the plurality of pixels to form an image. The M-bit gradation data consists of N-bit red data, N-bit green data and N-bit blue data. FIG. 2 illustrates 6-bit red data, R0 through R5, and 6-bit green data, G0 through G5, (6-bit blue data not shown) among 18-bit gradation data representing the gradation of a single pixel.

The gradation data stored in the memory 100 is read and transmitted to the multiplexer unit through a scan port included in the memory 100. The multiplexer unit includes at least one multiplexer 300.

The multiplexer unit receives M-bit gradation data and transmits the M-bit gradation data through L transmission lines (L is less than M). To transmit the M-bit gradation data through the L transmission lines, the multiplexer unit may use an M/L-to-1 multiplexer. In FIG. 2, gradation data representing the gradation of a single pixel has 18 bits and the multiplexer unit uses a 6-to-1 multiplexer that receives 6-bit gradation data for each color and sequentially outputs the 6-bit gradation data bits for each color. Here, the 6-to-1 multiplexer serially transmits the 6-bit gradation data bits over a single line in response to a predetermined control signal Ctrl_mux[5:0] from the control signal generator 400.

While a conventional driving IC transmits gradation data of each pixel in parallel through M transmission lines, the driving IC according to an exemplary embodiment of the present invention serially gradation data between the memory 100 and the source driver 200 through L transmission lines (L is less than M). Accordingly, the number of transmission lines connected between the memory 100 and the source driver 200 and the routing space between the memory 100 and the source driver 200 can be reduced.

The gradation data serially output from each multiplexer 300 of the multiplexer unit is input to each data processor 210 of the source driver 200. The data processor 210 receives the gradation data and sequentially processes it for inversion or for black and white display. Accordingly, the number of data processors 210 required for processing the gradation data can be reduced compared to the case where bits of gradation data input in parallel are simultaneously processed. In the case of the system shown in FIG. 2, each data processor 210 serially receives 6-bit gradation data and sequentially processes the 6-bit gradation data, and, thus, three data processors are needed for the 18 bits of gradation data for a single pixel.

The source driver 200 may further include a plurality of latch units 220 each being connected to each data processor 210. The latch unit 220 serially receives M/L-bit gradation data processed by the data processor 210 from the data processor 210. In the system shown in FIG. 2, the latch unit 220 serially receives the 6-bit gradation data, and the serially input gradation data is latched by the latch unit 220 and output to the corresponding level shifter 230. The latch unit 220 latches the gradation data serially input thereto in response to a predetermined control signal Ctrl_latch[5:0] from the control signal generator 400 and outputs the latched gradation data to the level shifter 230 through respective lines.

The gradation data output from the latch unit 220 is transmitted to the pixels included in the panel (not shown) via the level shifter 230, the decoder 240 and the buffer amplifier 250 through a plurality of data lines. The panel displays an image with gradations corresponding to the R, G and B data transmitted thereto.

The driving IC for a display device according to an exemplary embodiment of the present invention may further include the control signal generator 400. The control signal generator 400 generates the control signal Ctrl_mux[5:0] for controlling the multiplexer 300. The control signal Ctrl_mux[5:0] may be identical to the control signal Ctrl_latch[5:0] for controlling the latch unit 220, so that a period in which the multiplexer 300 outputs the gradation data corresponds to a period in which the latch 220 receives the gradation data.

Furthermore, the control signal generator 400 receives K predetermined input signals C1 through CK and generates the control Ctrl_mux[5:0] in synchronization with the input signals C1 through CK in order to correctly transmit the gradation data from the multiplexer 300 in response to the control signal Ctrl_mux[5:0]. When 18-bit gradation data is transmitted through three transmission lines from three multiplexers 300, for example, the control signal Ctrl_mux[5:0] consists of six signals. In this case, three input signals are needed.

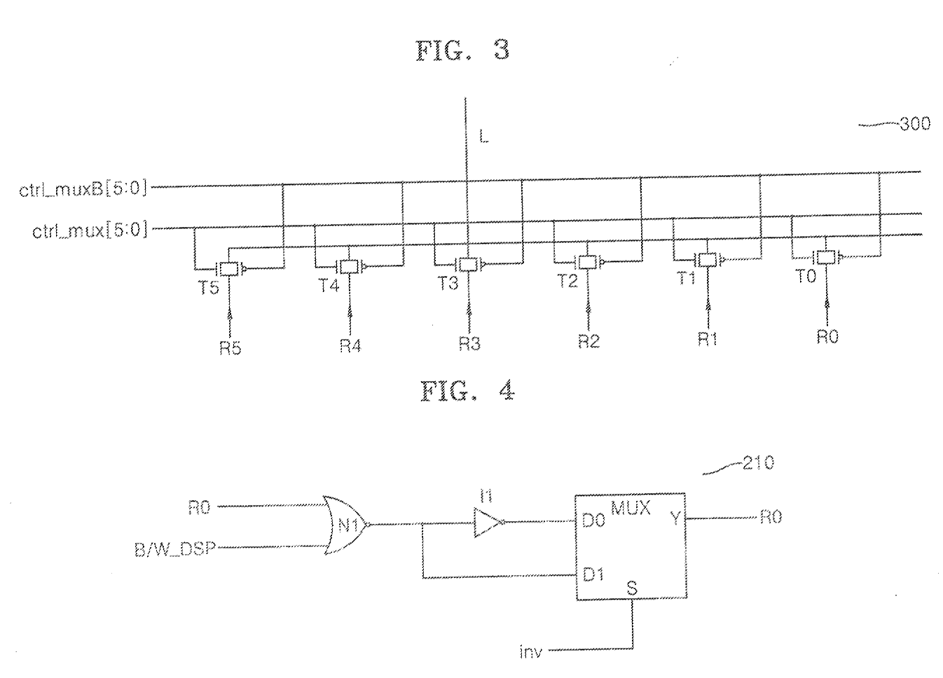

FIG. 3 is a circuit diagram of the multiplexer 300 used in the system shown in FIG. 2. When the multiplexer unit serially transmits M gradation data through L transmission lines, the multiplexer unit includes at least one M/L-to-1 multiplexer. For example, the M/L-to-1 multiplexer 300 receives 6-bit gradation data R0 through R5 and sequentially outputs the 6-bit gradation data bits. The M/L-to-1 multiplexer 300 includes a plurality of transfer gates T0 through T5, to which the gradation data bits are respectively input.

The plurality of transfer gates T0 through T5 are controlled by the predetermined control signal ctrl_mux[5:0] and an inverted control signal ctrl_muxB[5:0]. The control signal ctrl_mux[5:0] can be generated by the control signal generator 400 of FIG. 2, as described above, and the inverted control signal ctrl_muxB[5:0] can be obtained by inverting the control signal ctrl_mux[5:0].

As described above, the multiplexer 300 receives the 6-bit gradation data R0 through R5 and sequentially outputs the 6-bit gradation data bits. The control signal ctrl_mux[5:0] includes six signals ctrl_mux[0] through ctrl_mux[5] (not shown) that are respectively input to the plurality of transfer gates T0 through T5 through different control signal lines. The gradation data R0 through R5 respectively input to the transfer gates T0 through T5 can be sequentially output by sequentially enabling the control signals ctrl_mux[0] through ctrl_mux[5].

The multiplexer 300 can further include a latch (not shown) for holding the 6-bit gradation data to simultaneously input the 6-bit gradation data to the transfer gates T0 through T5.

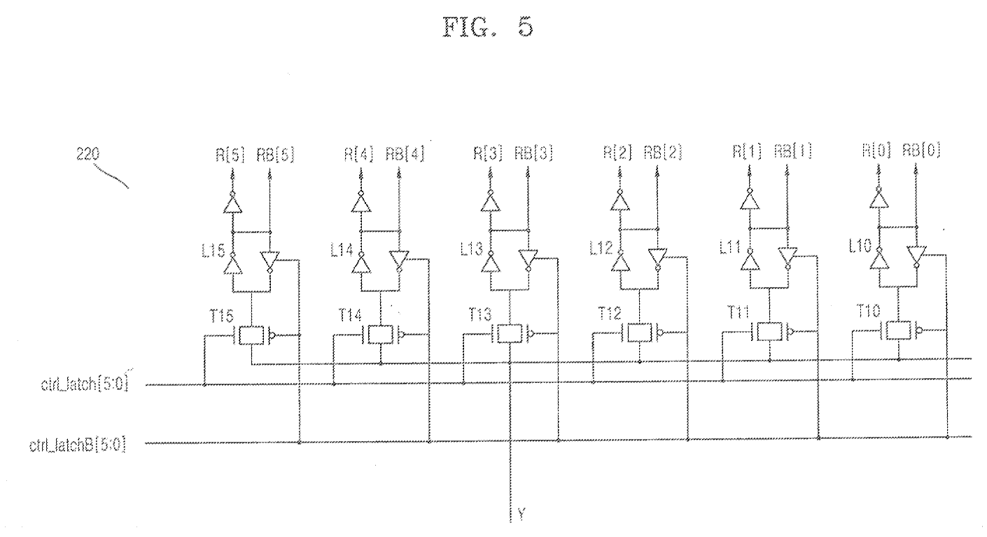

FIG. 4 is a circuit diagram of the data processor 210 used in the system shown in FIG. 2. Referring to FIG. 4, the data processor 200 includes a NOR gate N1, an inverter I1 and a multiplexer MUX. The data processor 210 sequentially processes gradation data serially input thereto for inversion or for black and black and white display. FIG. 4 illustrates that the data processor 210 processes gradation data R0.

The gradation data R0 and a black and white display signal B/W_DSP are respectively input to two input terminals of the NOR gate N1. When the black and white display signal B/W_DSP is enabled, the signal output from the data processor 210 a logic “1” or “0”, depending on the design of the circuit, irrespective of the logic level of gradation data input to the data processor 210.

When the black and white display signal B/W_DSP is disabled, the NOR gate N1 inverts the gradation data R0. The inverted gradation data R0 is further inverted by the inverter I1 and then input to one input terminal D0 of the multiplexer MUX. The inverted gradation data R0 output from the NOR gate N1 is also input to the other input terminal D1 of the multiplexer MUX. A predetermined control signal inv is input to a control input terminal S of the multiplexer MUX and the gradation data R0 and the inverted gradation data RD are selectively output through an output terminal Y of the multiplexer MUX, in response to the control signal inv, thereby performing an inversion operation.

The data processor 210 processes the input gradation data R0 for inversion and for black and white display and then processes gradation data R1 input thereto following the gradation data R0. In this manner, the data processing operation is sequentially performed on gradation data R0 through R5 so as to reduce the number of data processors included in the source driver 200 by a factor of 6. As shown in FIG. 4, each data processor 210 can include a single NOR gate, a single inverter and a single multiplexer. The size of the source driver 200 can be reduced by decreasing the number of data processors that are required.

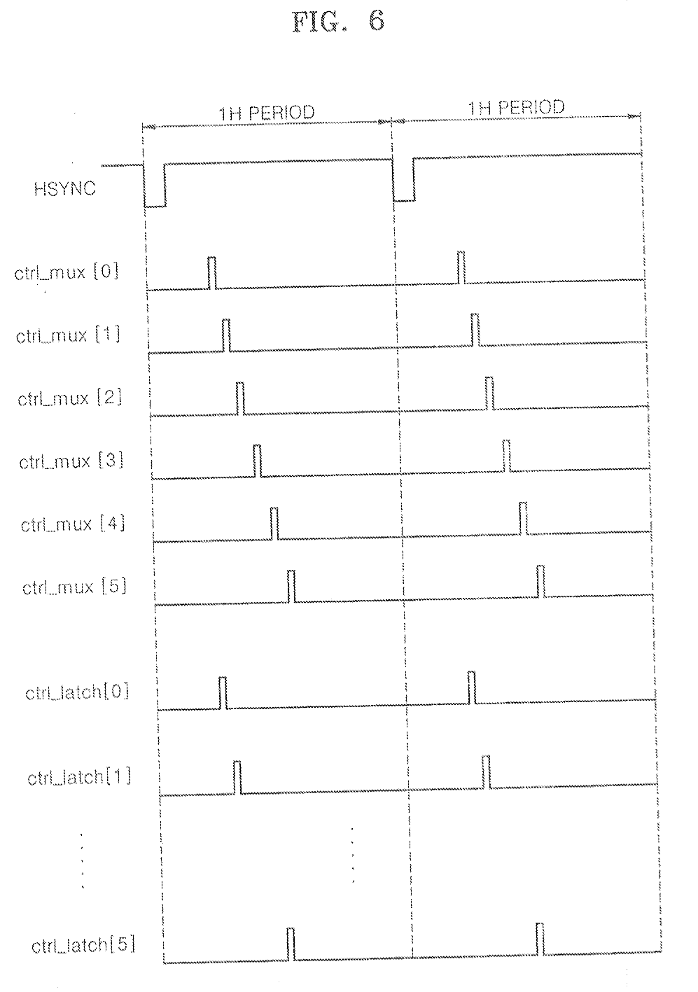

FIG. 5 is a circuit diagram of the latch unit 220 of FIG. 2. Referring to FIG. 5, the latch unit 220 serially receives the gradation data output from the data processor 210 and latches the received gradation data. The latch unit 220 is connected to the output terminal Y of the multiplexer MUX included in the data processor 210 (illustrated in FIG. 4) and receives the gradation data R0 through R5.

The latch unit 220 includes a plurality of transfer gates, for example, six transfer gates T10 through T15. The transfer gates T10 through T15 are controlled by a predetermined control signal ctrl_latch[5:0] from the control signal generator 400 and an inverted control signal ctrl_latchB[5:0]. It is preferable that the control signal ctrl_latch[5:0] be identical to the control signal ctrl_mux[5:0] for the controlling the multiplexer 300, as described above. The inverted control signal ctrl_latchB[5:0] can be obtained by inverting the control signal ctrl_latch[5:0 ].

The control signal ctrl_latch[5:0] includes six signals ctrl_latch[0] through ctrl_latch[5] (not shown) that are respectively applied to the transfer gates T10 through T15 through different control signal lines.

The latch unit 220 can further include a latch that is connected to each of the transfer gates T10 through T15 to latch one-bit gradation data input from each of the transfer gates T10 through T15. FIG. 5 shows six latches L10 through L15 respectively connected to the six transfer gates T10 through T15.

The serially input gradation data R0 through R5 can be respectively input to the transfer gates T10 through T15 by sequentially enabling the control signals ctrl_latch[0] through ctrl_latch[5]. More specifically, the control signal ctrl_latch[0] and gradation data R0 are enabled so that the gradation data R0 is transferred to the latch L10 thorough the transfer gate T10. Then, the control signal ctrl_latch[1] and the gradation data R1 are enabled such that the gradation data R1 is transferred to the latch L11 through the transfer gate T11. In this manner, the serially input gradation data R0 through R5 are respectively transferred to the latches L10 through L15.

The gradation data R0 through R5 transferred to the latches L10 through L15 are output to the level shifter 230 used in the system shown in FIG. 2 through respective lines and then converted into analog signals by the decoder 240 and the buffer amplifier 250 and transmitted to a panel (not shown).

The operation of the diagram IC for a display device according to an exemplary embodiment of the present invention will now be explained in detail.

FIG. 6 is a waveform diagram of the control signals input to the driving IC of FIG. 2. In particular, FIG. 6 illustrates the waveforms of the control signals input to the driving IC of FIG. 2 when the multiplexer 300 of FIG. 2 is a 6-to-1 multiplexer.

When a signal HSYNC representing a data signal input period of a single row of the matrix on the panel (not shown) is enabled, the control signals ctrl_mux[5:0] and ctrl_latch2[5:0] are enabled. It is preferable that the control signal ctrl_mux[5:0] be identical to the control signal ctrl_latch[5:0].

The control signal ctrl_mux[0] is enabled, and thus the gradation data R0 is transferred from the multiplexer 300 to the data processor 210 through a single transmission line. The data processor 210 processes the gradation data R0 for inversion or black/white display if required and outputs the processed gradation data R0. The gradation data R0 output from the data processor 210 is input to the latch unit 220. In this case, the gradation data R0 is transferred to the latch L10 through the transfer gate T10 because the control signal ctrl_latch[1] is enabled.

Then, the control signals ctrl_mux[1] and ctrl_latch[1] are enabled and, thus, the gradation data R1 is transferred from the multiplexer 300 to the data processor 210 through a transmission line. The gradation data R1 processed by the data processor 210 is transferred to the late L11 through the transfer gate T11 of the latch unit 220. In this manner, the gradation data R0 though R5 are latched by the latches L10 through L15 and output to the level shifter 230.

The data processor 210 is composed of logic gates. A period in which the multiplexer 300 is not operated may exist between enabled periods of the control signals ctrl_mux[0] through ctrl_mux[5], as illustrated in FIG. 6. In this period in which the multiplexer 300 is not operated, the input terminal of the data processor 210 may be left floating, which increases leakage current. To solve this problem, the driving IC for a display device according to an exemplary embodiment of the present invention can be constructed as follows.

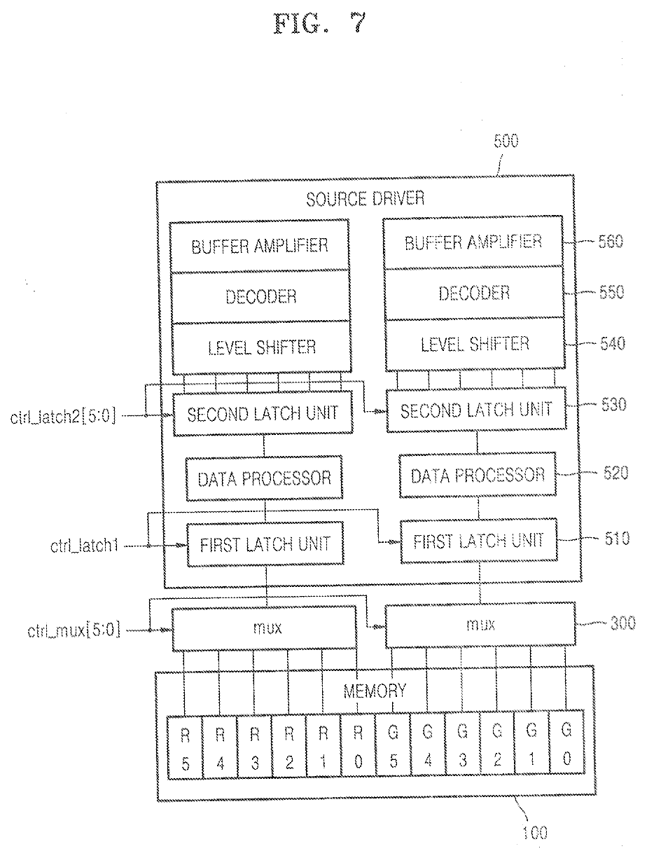

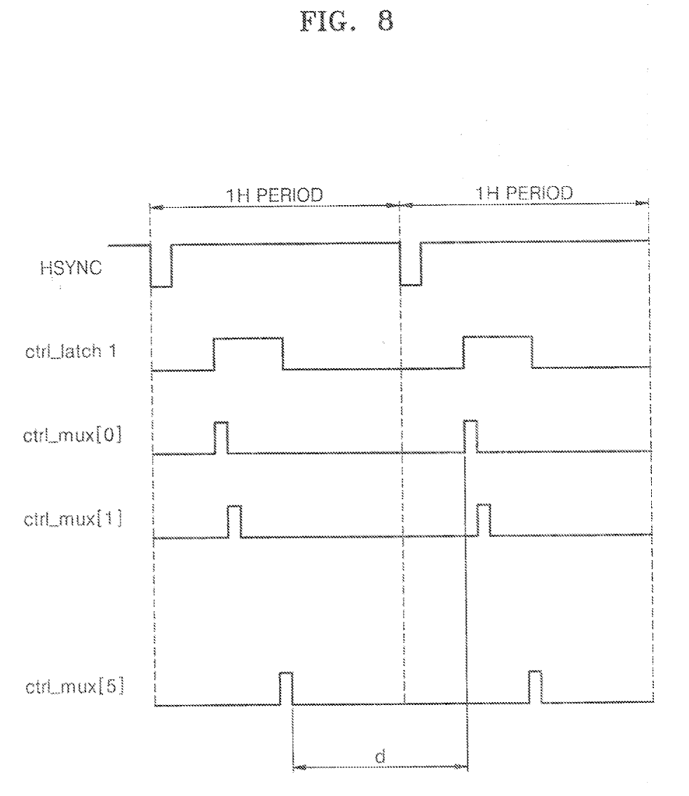

FIG. 7 is a block diagram of a driving IC for a display device according to an exemplary embodiment of the present invention. Detailed explanations of the components of the driving IC of FIG. 7 are omitted because they are identical to those of the driving IC of FIG. 2.

Referring to FIG. 7, the driving IC includes a memory 100, a source driver 500 and a multiplexer unit. The source driver 500 receives gradation data from the memory 100, converts the gradation data into an analog signal and transmits the analog signal to a panel (not shown). The source driver 500 includes at least one first latch unit 510, at least one data processor 520, at least one second latch unit 530, at least one level shifter 540, at least one decoder 550 and at least one buffer amplifier 560. The multiplexer unit includes at least one multiplexer 300.

The driving IC may further include a control signal generator (not shown) that generates the control signals for controlling the source driver 500 and the multiplexer unit. The multiplexer unit and the second latch unit 530 of the source driver 500 are controlled by control signals generated by the control signal generator as in the system shown in FIG. 2. The first latch unit 510 is controlled by a control signal generated by the control signal generator or by a separate control signal.

FIG. 8 is a waveform diagram of the control signals for driving the driving IC of FIG. 7. Each multiplexer 300 included in the multiplexer unit is controlled by a control signal ctrl_mux[5:0] output from the control signal generator. It is preferable that a control signal ctrl_latch2[5:0] for controlling the second latch unit 530 be identical to the control signal ctrl_mux[5]. In FIG. 8, an example of a control signal ctrl_latch1 input to the first latch unit 510 is illustrated.

When a signal HSYNC representing a data signal input period of a single row of the matrix of the panel (not shown) is enabled, the control signal ctrl_latch1 for controlling the first latch unit 510 is enabled and the control signals ctrl_mux[0] through ctrl_mux[5] are sequentially enabled during the enabled period of the control signal ctrl_latch1.

The control signal ctrl_mux[0] is enabled and thus one bit of gradation data (R0, for example) is transferred from the multiplexer 300 to the first latch unit 510. The gradation data R0 transferred to the first latch unit 510 is transmitted to the data processor 520. The gradation data R0 is processed by the data processor 520 and then sent to the second latch unit 520. In this manner, 6-bit gradation data is serially transferred from the multiplexer 300 to the second latch unit 530. The second latch unit 530 latches the 6-bit gradation data and outputs the latched 6-bit gradation data to the level shifter 540.

Then, the next control signal ctrl_mux[1] is enabled and the gradation data R1 is subjected to the aforementioned process. Subsequently, the control signals ctrl_mux[2], ctrl_mux[3], ctrl_mux[4] and ctrl_mux[5] are sequentially enabled and, thus, the gradation data R2, R3, R4 and R5 are subjected to the aforementioned process. A period “d” in which the control signals ctrl_mux[0] through ctrl_mux[5] are disabled such that the multiplexer 300 is not operating occurs between the period in which the control signal ctrl_mux[5] is enabled to transmit the gradation data R5 and the period in which the control signal ctrl_mux[0] is enabled to transmit the gradation data R0. In this case, the input terminal of the data processor 520 composed of logic gates is left floating, which increases leakage current. In an exemplary embodiment of the present invention, however, the first latch unit 510 latches the gradation data R5 and transfers the gradation data R5 to the input terminal of the data processor 520 during the period “d” in which the multiplexer 300 is not operated, and thus the problem caused by the leak-age current can be solved.

The control signals ctrl_mux[5:0] and ctrl_latch[5:0] shown in FIG. 6, instead of the control signals ctrl_mux[5:0], and ctrl_latch2[5:0], can be applied to the driving IC of FIG. 7. In this case, a period in which the multiplexer 300 is not operating occurs between the control signals, for example, between ctrl_mux[0] and ctrl_mux[1] and between ctrl_mux[1] and ctrl_mux[2]. The first latch unit 510 latches the gradation data right before the period in which the multiplexer 300 is not operating and transfers the latched gradation data to the input terminal of the data processor 520. Accordingly, the aforementioned problem caused by the leakage current can be solved.

The present invention is not limited to just the transmission of 18-bit gradation data by three 6-to-1 multiplexers through three transmission lines, as in the above-described exemplary embodiments. For example, the 18-bit gradation data can be transmitted using two 9-to-1 multiplexers through two transmission lines. Furthermore, when gradation data for representing the gradation of one pixel has a number of bits other than 18, a multiplexer having a different multiplexing characteristic can be used to transmit the gradation data.

According to exemplary embodiments of the present invention, gradation data stored in a memory is serially transmitted to a source driver and the serially transmitted gradation data is sequentially processed, so that a routing space between the memory and the source driver and the number of circuits included in the source driver can be reduced. Accordingly, the degree of integration of the driving IC can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A driving IC for a display device including a plurality of pixels whose respective gradations are represented M-bit gradation data, the driving IC comprising:
a memory storing gradation data for representing respective gradations of the plurality of pixels;
a multiplexer unit receiving the gradation data from the memory and transmitting the M-bit gradation data for representing a gradation of each of the plurality of pixels through L transmission lines, where L is less than M; and
a source driver serially receiving the gradation data through the L transmission lines and sequentially processing the serially received gradation data.

2. The driving IC of claim 1, wherein the multiplexer unit comprises at least one M/L-to-1 multiplexer, where M/L is an integer.

3. The driving IC of claim 2, wherein the M/L-to-1 multiplexer receives the M/L-bit gradation data and sequentially outputs the received gradation data through a single transmission line.

4. The driving IC of claim 1, wherein the source driver comprises at least one data processor that sequentially processes the gradation data serially input thereto through a transmission line.

5. The driving IC of claim 4, wherein the multiplexer unit comprises at least one M/L-to-1 multiplexer, and the data processor is connected to the M/L-to-1 multiplexer through a single transmission line and sequentially processes M/L-bit gradation data serially input thereto through the transmission line.

6. The driving IC of claim 5, wherein the source driver further comprises at least one latch unit connected to the data processor.

7. The driving IC of claim 6, wherein the latch unit serially receives the M/L-bit gradation data processed by the data processor, latches the received M/L-bit gradation data, and outputs the latched M/L-bit gradation data in parallel.

8. A driving IC for a display device including a plurality of pixels whose respective gradations are represented by M-bit gradation data, the driving IC comprising:
a memory storing gradation data for representing respective gradations of the plurality of pixels;
a multiplexer unit comprising at least one M/L-to-1 multiplexer, where M/L is an integer, the multiplexer unit receiving the gradation data from the memory and transmitting the M-bit gradation data for representing a gradation of each of the plurality of pixels through L transmission lines, where L is less than M;
a source driver including at least one data processor that is connected to the M/L-to-1 multiplexer and serially receives M/L-bit gradation data from the M/L-to-1 multiplexer; and
a control signal generator generating a control signal for controlling the M/L-to-1 multiplexer to sequentially output the M/L-bit gradation data bits.

9. The driving IC of claim 8, wherein the data processor sequentially processes the serially input gradation data.

10. The driving IC of claim 9, wherein the source driver further comprises at least one latch unit connected to the data processor.

11. The driving IC of claim 10, wherein the latch unit serially receives the M/L-bit gradation data processed by the data processor, latches the received M/L-bit gradation data, and outputs the latched M/L-bit gradation data in parallel.

12. The driving IC of claim 11, wherein the latch unit is controlled by the control signal generated by the control signal generator.

13. The driving IC of claim 8, wherein the control signal includes M/L signals respectively transmitted through M/L lines.

14. The driving IC of claim 13, wherein the control signal generator generates the control signal in synchronization with K predetermined input signals where K is an integer.

15. A driving IC for a display device including a plurality of pixels whose respective gradations are represented by M-bit gradation data, the driving IC comprising:
a memory storing gradation data for representing respective gradations of the plurality of pixels;
a multiplexer unit receiving the gradation data from the memory and transmitting the M-bit gradation data for representing a gradation of each of the plurality of pixels through L transmission lines, L is less than M; and
a source driver serially receiving the gradation data through the L transmission lines and sequentially processing the serially received gradation data.
wherein the source driver includes at least one first latch unit connected to the multiplexer unit through a transmission line to receive and latch the gradation data, and at least one data processor receiving the gradation data serially output from the first latch unit and sequentially processing the gradation data.

16. The driving IC of claim 15, wherein the multiplexer unit comprises at least one M/L-to-1 multiplexer, where M/L is an integer.

17. The driving IC of claim 16, wherein the multiplexer receives M/L-bit gradation data and sequentially outputs the M/L-bit gradation data bits through a single transmission line.

18. The driving IC of claim 15, wherein the multiplexer unit comprises at least one M/L-to-1 multiplexer, where M/L is a integer, and each first latch of the first latch unit is connected to each multiplexer of the multiplexer unit through a respective transmission line.

19. The driving IC of claim 18, wherein the data processor is connected to the first latch unit and sequentially processes the serially input M/L-bit gradation data.

20. The driving IC of claim 19, wherein the source driver further comprises at least one second latch unit connected to the data processor, the second latch unit serially receiving the gradation data processed by the data processor.

21. The driving IC of claim 20, wherein the second latch unit serially receives the M/L-bit gradation data processed by each data processor, latches the received M/L-bit gradation data, and outputs the latched M/L-bit gradation data in parallel.

22. The driving IC of claim 15, wherein the multiplexer unit includes at least one M/L-to-1 multiplexer, and further comprising a control signal generator generating a control signal for controlling the M/L-to-1 multiplexer to sequentially output the M/L-bit gradation data bits.

23. The driving IC of claim 22, further comprising at least one second latch unit connected to the data processor, the second latch unit serially receiving the gradation data processed by the data processor and being controlled by the control signal generated by the control signal generator.

24. The driving IC of claim 23, wherein the control signal includes M/L signals respectively transmitted through M/L lines.

25. The driving of IC claim 24, wherein the control signal generator generates the control signal in synchronization with K predetermined signals, where K is an integer.
